(19) United States
(12) Patent Application Publication
(10) Pub. No.: US 2013/0286924 A1
(43) Pub. Date: Oct. 31, 2013

(54) METHOD, DEVICE AND USER EQUIPMENT FOR OBTAINING SERVICE RECEPTION STATE OF USER EQUIPMENT SIDE FROM NETWORK SIDE

(71) Applicants: Youjun Gao, Beijing (CN); Zhenping Hu, Beijing (CN)

(72) Inventors: Youjun Gao, Beijing (CN); Zhenping Hu, Beijing (CN)

(73) Assignee: CHINA MOBILE COMMUNICATIONS CORPORATION, Beijing (CN)

(21) Appl. No.: 13/805,786

(22) PCT Filed: Jun. 21, 2011
(86) PCT No.: PCT/CN11/01038

§ 371 Date: Jan. 31, 2013

(30) Foreign Application Priority Data
Jun. 21, 2010 (CN) 201010212320.5

(51) Int. Cl. H04W 24/02

(52) U.S. Cl. CPC H04W 24/02
USPC 370/312

(57) ABSTRACT

An embodiment of the present disclosure discloses a method, device and UE for obtaining a service reception state of a UE side from a network side. The method comprises steps of: transmitting to the UE side an indication to respond the service reception state of an MBMS by the network side; and receiving by the network side the service reception state of the MBMS responded by the UE side according to the indication. According to the embodiment, the network side may obtain the service reception state of the MBMS of the UE, which facilitates optimizing an issuance policy for the MBMS.

### CROSS-REFERENCE TO RELATED APPLICATION

This application claims priority to and benefits of Chinese Patent Application Serial No. 201010212320.5, filed with the State Intellectual Property Office of P. R. China on Jun. 21, 2010 with the title “METHOD, DEVICE AND USER EQUIPMENT FOR OBTAINING SERVICE RECEPTION STATE OF USER EQUIPMENT SIDE FROM NETWORK SIDE”, the entire content of which is incorporated herein by reference.

### BACKGROUND OF THE INVENTION

1. Field of the Invention

This disclosure relates to a communication field and particularly to a method, device and UE (user equipment) for obtaining a service reception state of a UE side from a network side.

2. Description of the Prior Art

In an MBMS (Multimedia Broadcast Multicast Service) system of R9 (Release 9) of LTE (Long Term Evolution), the network side issues an occupation information of the MBMS through a system broadcast message and an MCCH (MBMS point-to-multipoint Control Channel) and the UE(s) obtain a resource configuration information of the MBMS by reading the system broadcast message and the contents on the MCCH, and accordingly the UE(s) receive the MBMS by employing a corresponding resource.

The MCCH message is a message adhered to the MBMS and comprises: an MBMS information for indicating the MBMS available to UE(s) in each cell; and for each MBMS, a service ID (identity), a session ID, a resource configuration of each service and a wireless carrier release indicator and the like.

When the MBMS changes, for example when a new MBMS is generated or a new MBMS session takes place, the network side needs to notify the UE(s) of it. Specifically speaking, the network side transmits a notification notifying a change of the MCCH to UE(s). When a UE receives the notification, it listens to the MCCH to obtain a changed MCCH message and to receive the MBMS according to the changed MCCH message accordingly.

However, in the MBMS system specified in the LTE R9, there is only a downlink MBMS transmission and the network side may not obtain the service state of the MBMS at the UE side. Although currently a need for obtaining the service state of the MBMS of the UE side from the network side so as to optimize an issuance policy for the MBMS is proposed, there is still no actual technical solution as to how to obtain the service state of the MBMS of the UE side from the network side.

### SUMMARY OF THE INVENTION

The embodiment of the present disclosure discloses a method, device and UE for obtaining a service reception state of a UE side from a network side so that the network side may obtain the service reception state of the MBMS of the UE, which facilitates optimizing an issuance policy for the MBMS.

According to an aspect of the present disclosure, a method for obtaining a service reception state of a UE side from a network side is provided. The method comprises steps of: transmitting to the UE(s) an indication to respond the service reception state of an MBMS by the network side; and receiving by the network side the service reception state of the MBMS responded by the UE(s) at the UE side according to the indication.

According to another aspect of the present disclosure, a device for obtaining a service reception state of the UE(s) at a UE side from a network side is provided. The device comprises: a transmitting module, which is configured to transmit to the UE(s) at the UE side an indication to respond the service reception state of an MBMS; and a receiving module, which is configured to receive the service reception state of the MBMS responded by the UE(s) at the UE side according to the indication.

According to still another aspect of the present disclosure, a method for responding a service reception state is provided. The method comprises steps of: receiving by a UE an indication to respond the service reception state of an MBMS from a network side; and transmitting by the UE the service reception state of the MBMS according to the indication to the network side.

According to still another aspect of the present disclosure, a UE is provided. The UE comprises: a receiving module, which is configured to receive an indication to respond the service reception state of an MBMS from a network side; and a transmitting module, which is configured to transmit the service reception state of the MBMS according to the indication to the network side.

According to the above embodiments, the network side transmits the indication to the UE(s) to respond the service reception state of the MBMS and the UE(s) respond the service reception state of the MBMS according to the indication. On one side, the network side may obtain the service reception state of the MBMS so as to optimize the issuance policy for the MBMS; on the other side, compared with a condition in which the UE(s) voluntarily report the service reception state of the MBMS, by issuing a corresponding indication from the network side, the UE(s) may respond the service reception state of the MBMS according to the indication and therefore the network resource may be saved since in many of the cases, when the UE(s) voluntarily report the service reception state of the MBMS, the network side does not need the service reception state of the MBMS at all and thus the network resource is wasted for reporting the service reception state of the MBMS.

In addition, in the above embodiments, the network side uses an existent message or a newly added specific signaling message to transmit the indication to the UE(s) to respond the service reception state of the MBMS. When the network side uses the existent message, for example a system broadcast message indicating the MBMS, an MCCH message for transmitting the MBMS and resource configuration information, a physical layer signaling message (i.e. notification message) to notify a change of the resource configuration of the service reception state of the MBMS. Since all these messages are messages having to be transmitted by the network side in the current MBMS system, all the UEs may receive the indication to respond the service reception state of the MBMS, thus avoiding adding new signaling messages and saving signaling overheads.

### BRIEF DESCRIPTION OF THE DRAWINGS

FIG. 1 is a flow chart showing a method for a network side to obtain a service reception state of a UE side according to an embodiment of the present disclosure;

FIG. 2 is a flow chart showing a method for receiving a signaling message newly added and dedicated to notify the UE(s) to respond the service reception state of an MBMS and responding the service reception state of the MBMS according to a broadcast message from the network side according to an embodiment of the present disclosure;

FIG. 3 is a schematic diagram showing a structure of a device for obtaining a service reception state of a UE side from a network side;

FIG. 4 is a flow chart showing a method for responding a service reception state according to an embodiment of the present disclosure; and

FIG. 5 is a schematic diagram showing a structure of a UE according to an embodiment of the present disclosure.

### DETAILED DESCRIPTION OF THE PREFERRED EMBODIMENTS

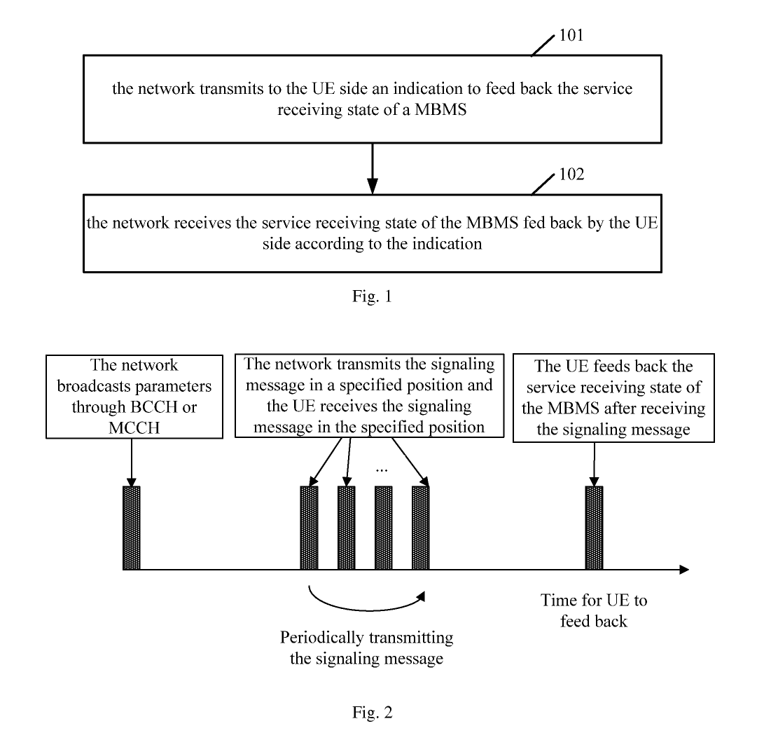

FIG. 1 is a flow chart showing a method for a network side to obtain a service reception state of a UE side according to an embodiment of the present disclosure.

As shown in FIG. 1, the method comprises the following steps.

In step 101, the network side transmits to the UE(s) an indication to respond the service reception state of an MBMS.

The network side may set an indication indicating the UE(s) to respond the service reception state of the MBMS in a system broadcast message indicating the MBMS, in a MCCH message transmitting the MBMS and a resource configuration, in a physical layer signaling message, or in a signaling message newly added and dedicated to notify the UE(s) to respond the service reception state of the MBMS.

The indicator may take up one bit or take up a bit string constituted by multiple bits. The bit string may indicate the UE(s) to respond the service reception states of all or a part of the MBMSs, or different bits within the bit string may indicate the UE(s) to respond the service reception state of different types of MBMSs, or the bit string may indicate the UE(s) in different MBSFNs (Multimedia Broadcast Single Frequency Network) to respond the service reception state of the MBMS, or the bit string may indicate the UE(s) to respond the service reception state of some specified MBMSs.

In step 102, the network side receives the service reception state of the MBMS responded by the UE(s) according to the indication.

Embodiments of the present disclosure will be illustrated in detail with reference to different messages carrying the indicator.

When the network side sets an indication indicating the UE(s) to respond the service reception state of the MBMS in a system broadcast message indicating the MBMS, it may set in the system broadcast message a first indication indicating all the UE(s) to respond the service reception state of the MBMS; or set in an MBSFN configuration information of the system broadcast message a second indication indicating the UE(s) within a corresponding MBSFN area (i.e., receiving the MBMS from a corresponding MBSFN area) to respond the service reception state of the MBMS.

At present, the system broadcast message indicating the MBMS comprises a SIB 13 (System Information Block 13, SIB13). According to the embodiments of the present disclosure, the first indication and the second indication may be set in different positions of the SIB 13 to indicate the UE to respond the service reception state of the MBMS.

An example will be illustrated with reference to setting the first indication and the second indication in a corresponding message body of the LET R9 system.

The position of the first indication in the SIB 13 message body is as follows:

```
  -- ASN1START
  SystemInformationBlockType13-r9 ::= SEQUENCE {
```

| | |
|---|---|
| mbsfn-AreaInfoList-r9 | MBSFN-AreaInfoList-r9, |

statusReportIndicator BOOLEAN

| | | |
|---|---|---|
| notificationConfig-r9 | MBMS-NotificationConfig-r9, | |
| lateR9NonCriticalExtension | OCTET STRING | OPTIONAL,-- Need |
| OP | | |
| ... | | |
| } | | |
| -- ASN1STOP | | |

The bolded and underlined “statusReportIndicator BOOLEAN” represents the first indication, which is out of a configuration information body of respective MBSFNs.

The position of the second indication in the SIB 13 message body is as follows:

| | |
|---|---|
| -- ASN1START | |
| MBSFN-AreaInfoList-r9 ::= | SEQUENCE (SIZE(1..maxMBSFN-Area)) OF MBSFN-AreaInfo- |
| r9 | |
| MBSFN-AreaInfo-r9 ::= | SEQUENCE { |

statusReportIndicator BOOLEAN

| | |
|---|---|
| mbsfn-AreaId-r9 | INTEGER (0..255), |
| non-MBSFNregionLength | ENUMERATED {s1, s2}, |
| notificationIndicator-r9 | INTEGER (0..7), |
| mcch-Config-r9 | SEQUENCE { |
| mcch-RepetitionPeriod-r9 | ENUMERATED {rf32, rf64, rf128, |
| rf256}, | |
| mcch-Offset-r9 | INTEGER (0..10), |
| mcch-ModificationPeriod-r9 | ENUMERATED {rf512, rf1024}, |
| sf-AllocInfo-r9 | BIT STRING (SIZE(6)), |
| signallingMCS-r9 | ENUMERATED {n2, n7, n13, n19} |
| }, | |
| ... | |
| } | |
| -- ASN1STOP | |

The bolded and underlined “statusReportIndicator BOOLEAN” represents the second indication, which is within a configuration information body of a MBSFN.

When the second indication is set in the configuration information body of the MBSFN, UE(s) in a specified area may be indicated to respond the service reception state of the MBMS, i.e., UE(s) receiving the MBMS in the specified MBSFN area are indicated to respond the service reception state of the MBMS, which is convenient for considering the service reception state of the MBMS in different areas.

The method for setting the first indication and the second indication in a corresponding message body of the other version systems is the same as that of the LTE R9 system and thus will not be illustrated in detail here.

When the network side sets an indication indicating the UE to respond the service reception state of the MBMS in a MCCH message transmitting a service and resource configuration of the MBMS, it may set in the MCCH message a third indication indicating the UE to respond all the service reception states of all the MBMSs or of some specific MBMSs; or set in an MBMS configuration information of the MCCH message a fourth indication indicating the UE to respond the service reception state of the MBMS.

According to the embodiment of the present disclosure, the third indication and the fourth indication may be set in different positions in the MCCH message to indicate the UE to respond the service reception state of the MBMS. An example will be illustrated with reference to the LTE R9 system.

The position of the third indication in the MCCH message is as follows:

| | |
|---|---|
| -- ASN1START | |
| MCCH-Message ::= | SEQUENCE { |
| message | MCCH-MessageType |
| } | |

| | |
|---|---|
| MCCH-MessageType ::= CHOICE { | |
| c1 | CHOICE { |
| mbsfnAreaConfiguration-r9 | MBSFNAreaConfiguration-r9 |

```
    StateReportIndicator BOOLEAN
    },
```

| | |
|---|---|
| messageClassExtension | SEQUENCE { } |
| } | |
| -- ASN1STOP | |

The bolded and underlined “statusReportIndicator BOOLEAN” represents the third indication.

In addition, the third indication may be set in the MCCH message as follows:

Message StateReportIndicator {
Service ID 1
Service ID 2
...
Service ID n
}
in which n is a natural number.

According to the above method for setting the third indication, some or all MBMSs may be extracted from the MBMSs issued from the network side, so as to indicate the UE(s) to respond the service reception state of the extracted MBMSs.

The position of the fourth indication in the MCCH message is as follows:

| | |
|---|---|
| -- ASN1START | |
| PMCH-InfoList-r9 ::= | SEQUENCE (SIZE (0..maxPMCH-PerMBSFN)) OF PMCH- |
| Info-r9 | |
| PMCH-Info-r9 ::= | SEQUENCE { |
| pmch-Config-r9 | PMCH-Config-r9, |
| mbms-SessionInfoList-r9 | MBMS-SessionInfoList-r9, |
| ... | |
| } | |
| MBMS-SessionInfoList-r9 ::= | SEQUENCE (SIZE (0..maxSessionPerPMCH)) OF MBMS-SessionInfo-r9 |
| MBMS-SessionInfo-r9 ::= | SEQUENCE { |
| tmgi-r9 | TMGI-r9, |

statusReportIndicator BOOLEAN

| | |
|---|---|
| sessionId-r9 | OCTET STRING (SIZE (1)) OPTIONAL, -- Need |
| OR | |
| logicalChannelIdentity-r9 | INTEGER (0..maxSessionPerPMCH-1), |
| ... | |
| } | |
| PMCH-Config-r9 ::= | SEQUENCE { |
| sf-AllocEnd-r9 | INTEGER (0..1535), |
| dataMCS-r9 | INTEGER (0..28), |

mch-SchedulingPeriod-r9 ENUMERATED {

| | |
|---|---|
| | rf8, rf16, rf32, rf64, rf128, rf256, rf512, rf1024}, |
| ... | |
| } | |
| TMGI-r9 ::= | SEQUENCE { |
| plmn-Id-r9 | CHOICE { |
| plmn-Index-r9 | INTEGER (1..6), |
| explicitValue-r9 | LMN-Identity |
| }, | |
| serviceId-r9 | OCTET STRING (SIZE (3)) |
| } | |
| -- ASN1STOP | |

The bolded and underlined “statusReportIndicator BOOLEAN” represents the fourth indication, which is within a configuration information body of the MBMS.

The method for setting the third indication and the fourth indication in a corresponding message body of the other version systems is the same as that of the LTE R9 system and thus will not be illustrated in detail here.

By setting the third indication for the specified MBMSs in the MCCH message or by setting the fourth indication in the configuration information body of the MCCH message, the network side may obtain the service reception state of the specified MBMS so as to avoid obtaining the service reception state of the unnecessary MBMS and to save network resource.

When the network side sets the indication indicating the UE(s) to respond the service reception state of the MBMS in the physical layer signaling message which is typically for notifying a content change of the MCCH, remaining bits except bits which represent the content change of the MCCH corresponding to each MBSFN area in the signaling message used to notify the content change of the MCCH or remaining values except values which indicate the content change of the MCCH in the whole signaling message may be set to indicate the UE(s) to respond the service reception state of the MBMS, which is helpful to save signaling resource and to improve a utilization of the signaling message.

When the network side sets the indication indicating the UE(s) to respond the service reception state of the MBMS in the newly added and dedicated signaling message, the newly added and dedicated signaling message may be a RRC (Radio Resource Control) layer signaling message, a MAC (Medium Access Control) layer signaling message, or a physical layer signaling message. In addition, the newly added RRC layer signaling message may be a newly added BCCH (Broadcast Control Channel) or a newly added MCCH message.

The network side broadcasts a period and/or time offset amount and/or number of times of transmitting the signaling message newly added and dedicated to notify the UE(s) to respond the service reception state of the MBMS through the system broadcast message or the MCCH message, or broadcasts a period and/or time offset amount and/or number of times of transmitting the signaling message newly added and dedicated to notify the UE(s) to respond the service reception state of the MBMS through the system broadcast message or the MCCH message and a period and/or time window and/or number of times for the UE(s) to respond the service reception state of the MBMS, so that after each UE receives the broadcast message, it may receive the newly added signaling message by using a corresponding resource and respond the service reception state of the MBMS according to the signaling message.

The method for receiving the signaling message newly added and dedicated to notify the UE(s) to respond the service reception state of the MBMS and for responding the service reception state of the MBMS according to the broadcast message from the network side will be illustrated with reference to FIG. 2.

FIG. 2 is a flow chart showing a method for receiving a signaling message newly added and dedicated to notify the UE(s) to respond the service reception state of an MBMS and for responding the service reception state of the MBMS according to a broadcast message from the network side according to an embodiment of the present disclosure.

As shown in FIG. 2, the network side notifies a position of the signaling message carrying the indicator indicating the UE(s) to respond the service reception state of the MBMS through the BCCH or the MCCH. The network side may broadcast the period and/or time offset amount and/or number of times of transmitting the signaling message and may broadcast the period and/or time window and/or number of times for the UE(s) to respond the service reception state of the MBMS. The network side may transmit in the position the signaling message carrying the indicator indicating the UE(s) to respond the service reception state of the MBMS, and each UE may receive the signaling message in the position and respond the service reception state of the MBMS according to specified parameters, such as the number of times of responding the service reception state of the MBMS. For example, in FIG. 2, the number of times for each UE to respond the service reception state of the MBMS is once, i.e. the UE may only respond once for the same service reception state of the MBMS and the time window for the UE to respond the service reception state of the MBMS is also one (of course it may be N, i.e. the UE may respond information at the Nth sub-frame after receiving the indication). Parameters such as the period and the number of times for the UE to respond the service reception state of the MBMS may be negotiated and agreed in advance with the network side and the network side does not need to issue the parameters through the broadcast message. For example, when the period or the time offset amount is preset to be equal to a known parameter or a multiple of the known parameter, the network does not need to issue the period or the time offset amount.

The UE receives the signaling message in the corresponding position according to the parameters broadcasted from the network side. For example, when a result of a modulo operation on the period for transmitting the signaling message in a current system sub-frame equals to the time offset amount broadcasted from the network side, the UE will receive the signaling message in the current system sub-frame.

The service reception state of the MBMS responded by the UE(s) according to the indication may comprise: whether a UE will receive the MBMS, the MBSFN area ID information corresponding to the MBMS or the MBMS ID responded by a UE. The MBSFN area ID information corresponding to the MBMS or the MBMS ID may be directly responded to the network side, or the bit string constituted by multiple bits may be set in a response message, in which different bits in the bit string may be mapped to specified MBSFN area indicator or MBMS ID.

The MBSFN area indicator is different from the MBMS ID. The MBMSs with the same ID in different MBSFN areas may be different. Therefore, according to the MBSFN area indicator and the MBMS ID, it may be uniquely determined the MBMS of which a UE has responded the service reception state. Therefore, accuracy for the network side to determine the service reception state of the MBMS responded by a UE can be improved.

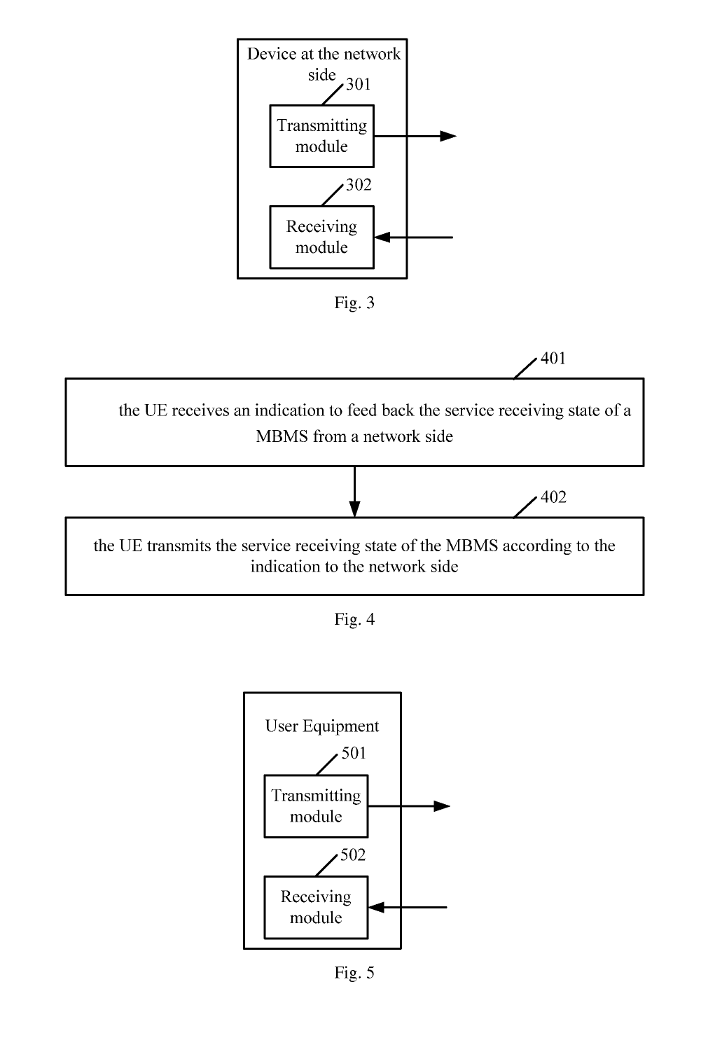

According to an embodiment of the present disclosure, a device for obtaining a service reception state of a UE side from a network side is provided. The device will be illustrated with reference to FIG. 3.

FIG. 3 is a schematic diagram showing a structure of a device for obtaining a service reception state of a UE side from a network side.

As shown in FIG. 3, the device may comprise a transmitting module 301 and a receiving module 302.

The transmitting module 301 may be configured to transmit to the UE side an indication to respond the service reception state of an MBMS. The receiving module 302 may be configured to receive the service reception state of the MBMS responded by the UE side according to the indication.

Specifically speaking, the transmitting module 301 may comprise a setting sub-module and a transmitting sub-module. The setting sub-module may be configure to set an indication indicating the UE(s) to respond the service reception state of the MBMS in a system broadcast message indicating the MBMS, in a MCCH message transmitting a resource configuration of the MBMS, in a physical layer signaling message, or in a signaling message newly added and dedicated to notify the UE(s) to respond the service reception state of the MBMS. The transmitting sub-module may be configured to transmit a message carrying the indicator to the UE(s).

The setting sub-module may set in the system broadcast message a first indication indicating all the UE(s) to respond the service reception state of the MBMS; or set in an MBSFN configuration information of the system broadcast message a second indication indicating the UE(s) receiving the MBMS from a corresponding MBSFN area to respond the service reception state of the MBMS.

The setting sub-module may also set in the MCCH message a third indication indicating the UE(s) to respond all the service reception states of all the MBMSs or of specific MBMSs; or set in an MBMS configuration information of the MCCH message a fourth indication indicating the UE(s) to respond the service reception state of the MBMS.

The setting sub-module may also set remaining bits except bits which represent the content change of the MCCH corresponding to each MBSFN area in the signaling message used to notify the content change of the MCCH or remaining values except values which indicate the content change of the MCCH in the signaling message indicate the UE(s) to respond the service reception state of the MBMS.

According to an embodiment of the present disclosure, a method for responding a service reception state is provided, which will be illustrated with reference to FIG. 4. As shown in FIG. 4, the method may comprise the following steps.

In step 401, a UE receives an indication to respond the service reception state of an MBMS from a network side.

In step 402, the UE transmits the service reception state of the MBMS according to the indication to the network side.

The UE may receive a message carrying an indicator indicating the UE to respond the service reception state of the MBMS and the message may comprise a system broadcast message indicating the MBMS, a MCCH message transmitting the MBMS and a resource configuration, a physical layer signaling message, or a signaling message newly added and dedicated to notify the UE(s) to respond the service reception state of the MBMS. The UE may transmit the service reception state of the MBMS according to the indication to the network side.

The service reception state of the MBMS from the UE side to the network side may comprise an MBSFN area ID information corresponding to the service reception state of the MBMS responded by the UE.

The service reception state of the MBMS from the UE side to the network side may further comprise an MBMS ID information corresponding to the service reception state of the MBMS responded by the UE.

According to an embodiment of the present disclosure, a UE may be provided, which will be illustrated with reference to FIG. 5.

FIG. 5 is a schematic diagram showing a structure of a UE according to an embodiment of the present disclosure.

As shown in FIG. 5, the UE may comprise a receiving module 501 and a transmitting module 502.

The receiving module 501 may be configured to receive an indication to respond the service reception state of an MBMS from a network side. The transmitting module 502 may be configured to transmit the service reception state of the MBMS according to the indication to the network side.

The receiving module 501 may receive a message carrying an indicator indicating the UE(s) to respond the service reception state of the MBMS and the message may comprise a system broadcast message indicating the MBMS, an MCCH message transmitting the MBMS and a resource configuration, a physical layer signaling message or a signaling message newly added and dedicated to notify the UE(s) to respond the service reception state of the MBMS. The transmitting module 502 may transmit the service reception state of the MBMS according to the indication to the network side.

The service reception state of the MBMS transmitted by the transmitting module 502 to the network side may comprise an MBSFN area ID information corresponding to the service reception state of the MBMS responded by the UE and may further comprise an MBMS ID information corresponding to the service reception state of the MBMS responded by the UE.

Apparently, those skilled in the art may make any changes and modifications without departing from spirit and principles of the disclosure. If the changes and modifications equal to the scope of claims and their equivalents, the present disclosure is intended to include all these changes and modifications.

Those skilled in the art may understand that the embodiments of the present disclosure may be implemented as a method, a system or a computer program product. Therefore, the present disclosure may be implemented by hardware solely, by software solely or by a combination of the hardware and software. Moreover, the present disclosure may be implemented by a computer program product as a computer readable storage medium (including but not limited to disk storage, CD-ROM and optical storage) storing computer readable program codes.

The present disclosure is illustrated with reference to flow charts and/or block diagrams of the method, device (system) and computer program product of the embodiments. It should be understood that the computer program instructions may realize each step and/or block and combinations of steps and/or blocks in the flow charts and/or block diagrams. These computer program instructions may be provided to a general purpose computer, a dedicated computer, an embedded processing machine or other programmable data processing device to generate a machine so that the computer or other programmable data processing device may execute the instructions to generate an apparatus to implement specified functions in one or more steps of the flow charts and/or one or more blocks of the block diagrams.

These computer program instructions may be stored in the computer readable storages that may boot the computer or other programmable data processing device to work to produce the instructions to generate a product comprising an instruction apparatus. The instruction apparatus implements specified functions in one or more steps of the flow charts and/or one or more blocks of the block diagrams.

These computer program instructions may be loaded in the computer or other programmable data processing device so that the computer or other programmable data processing device may execute a series of operation steps to generate the process realized by the computer and the instructions executed may implement specified functions in one or more steps of the flow charts and/or one or more blocks of the block diagrams.

Although explanatory embodiments have been shown and described, those skilled in the art may make changes and modifications to these embodiments when having basic idea of inventiveness. Therefore, the claims are intended to comprise preferred embodiments and changes and modifications falling into the scope of the present disclosure.

The above are only preferred embodiments and are not intended to limit the present disclosure. All changes, alternatives, and modifications falling into the scope of the claims and their equivalents are included in the scope of the disclosure.

1. A method for obtaining a service reception state of a user equipment (UE) side from a network side, comprising steps of:
transmitting to UE(s) an indication to respond the service reception state of an multimedia broadcast multicast service (MBMS) by the network side; and
receiving at the network side the service reception state of the MBMS responded by the UE(s) at the UE side according to the indication.

2. The method according to claim 1, wherein transmitting to the UE(s) an indication to respond the service reception state of an MBMS by the network side comprises:
setting by the network side an indication indicating the UE(s) to respond the service reception state of the MBMS in a system broadcast message indicating the MBMS, in an MBMS point-to-multipoint control channel (MCCH) message transmitting the MBMS and a resource configuration information, in a physical layer signaling message or in a signaling message newly added and dedicated to notify the UE(s) to respond the service reception state of the MBMS; and
transmitting by the network side a message carrying the indicator to the UE(s).

3. The method according to claim 2, wherein setting by the network side an indication indicating the UE(s) to respond the service reception state of the MBMS in a system broadcast message indicating the MBMS comprises:
setting in the system broadcast message a first indication indicating all the UE(s) to respond the service reception state of the MBMS; or
setting in an multicast broadcast single frequency network (MBSFN) configuration information of the system broadcast message a second indication indicating the UE(s) receiving the MBMS from a corresponding MBSFN area to respond the service reception state of the MBMS.

4. The method according to claim 3, wherein the system broadcast message indicating the MBMS information comprises a system information block 13 (SIB 13).

5. The method according to claim 2, wherein setting by the network side an indication indicating the UE(s) to respond the service reception state of the MBMS in an MCCH message transmitting the MBMS and a resource configuration information comprises:
setting in the MCCH message a third indication indicating the UE(s) to respond all the service reception states of all the MBMSs or of specific MBMS(s); or
setting in an MBMS configuration information of the MCCH message a fourth indication indicating the UE(s) to respond the service reception state of the MBMS, or
the physical layer signaling message comprises a signaling message notifying a content change of the MCCH and wherein the step of setting a indication indicating the UE(s) to respond the service reception state of the MBMS comprises:
making remaining bits except bits which represent the content change of the MCCH corresponding to each MBSFN area in the signaling message used to notify the content change of the MCCH or remaining values except values which indicate the content change of the MCCH in the signaling message indicate the UE(s) to respond the service reception state of the MBMS, or
wherein the signaling message newly added and dedicated to notify the UE(s) to respond the service reception state of the MBMS comprises a radio resource control (RRC) layer signaling message, a medium access control (MAC) layer signaling message or a physical layer signaling message.

6. (canceled)

7. (canceled)

8. The method according to claim 5, wherein the RRC layer signaling message comprises a broadcast control channel (BCCH) message or an MCCH message.

9. The method according to claim 2, further comprising steps of:
broadcasting by the network side a period and/or time offset amount and/or number of times of transmitting the signaling message newly added and dedicated to notify the UE(s) to respond the service reception state of the MBMS through the system broadcast message or the MCCH message, wherein the signaling message is transmitted by the network side, or
broadcasting by the network side a period and/or time offset amount and/or number of times of transmitting the signaling message newly added and dedicated to notify the UE(s) to respond the service reception state of the MBMS through the system broadcast message or the MCCH message and a period and/or time window and/or number of times for the UE(s) to respond the service reception state of the MBMS, wherein the signaling message is transmitted by the network side.

10. The method according to claim 1, wherein the service reception state of the MBMS responded by the UE(s) at the UE side according to the indication comprises: an MBSFN area ID information corresponding to the service reception state of the MBMS responded by the UE(s).

11. The method according to claim 10, wherein the service reception state of the MBMS responded by the UE(s) at the UE side according to the indication comprises an MBMS ID information which corresponds to each service reception state of the MBMS responded by the UE(s).

12. A device for obtaining a service reception state of a UE side from a network side, comprising:
a transmitting module, which is configured to transmit to the UE(s) an indication to respond the service reception state of MBMS(s); and
a receiving module, which is configured to receive the service reception state of the MBMS(s) responded by the UE(s) at the UE side according to the indication.

13. The device according to claim 12, wherein the transmitting module comprises:
a setting sub-module, which is configured to set an indication indicating the UE(s) to respond the service reception state of the MBMS in a system broadcast message indicating the MBMS information, in an MCCH message transmitting the MBMS and a resource configuration information, in a physical layer signaling message or in a signaling message newly added and dedicated to notify the UE(s) to respond the service reception state of the MBMS; and
a transmitting sub-module, which is configured to transmit a message carrying the indicator to the UE(s).

14. The device according to claim 13, wherein
the setting sub-module sets in the system broadcast message a first indication indicating all the UE(s) to respond the service reception state of the MBMS; or
the setting sub-module sets in an MBSFN configuration information of the system broadcast message a second indication indicating the UE(s) receiving the MBMS from a corresponding MBSFN area to respond the service reception state of the MBMS, or
the setting sub-module sets in the MCCH message a third indication indicating the UE(s) to respond all the service reception states of all the MBMSs or of specific MBMS(s); or
the setting sub-module sets in an MBMS configuration information of the MCCH message a fourth indication indicating the UE(s) to respond the service reception state of the MBMS, or
the setting sub-module sets remaining bits except bits which represent the content change of the MCCH corresponding to each MBSFN area in the signaling message used to notify the content change of the MCCH or remaining values except values which indicate the content change of the MCCH in the signaling message, so as to indicate the UE(s) to respond the service reception state of the MBMS.

15. (canceled)

16. (canceled)

17. A method for responding a service reception state, comprising steps of:
receiving by a UE an indication to respond the service reception state of an MBMS from a network side; and
transmitting by the UE the service reception state of the MBMS according to the indication to the network side.

18. The method according to claim 17, wherein receiving by a UE an indication to respond the service reception state of an MBMS from a network side comprises:
receiving by the UE a message with an indication indicating the UE to respond the service reception state of the MBMS, wherein the message comprises a system broadcast message indicating the MBMS, an MCCH message transmitting the MBMS and a resource configuration information, a physical layer signaling message or a signaling message newly added and dedicated to notify the UE(s) to respond the service reception state of the MBMS; and
wherein transmitting by the UE(s) the service reception state of the MBMS according to the indication to the network side comprises transmitting by the UE(s) the service reception state of the MBMS according to the indication.

19. The method according to claim 17, wherein the service reception state of the MBMS comprises an MBSFN area identity (ID) information corresponding to the service reception state of the MBMS responded by the UE(s).

20. The method according to claim 19, wherein the service reception state of the MBMS further comprises an MBMS ID information which corresponds to each service reception state of the MBMS responded by the UE(s).

21. A user equipment, comprising:
a receiving module, which is configured to receive an indication to respond the service reception state of an MBMS from a network side; and
a transmitting module, which is configured to transmit the service reception state of the MBMS according to the indication to the network side.

22. The user equipment according to claim 21, wherein
the receiving module receives a message carrying an indicator indicating the UE to respond the service reception state of the MBMS, wherein the message comprises a system broadcast message indicating the MBMS, an MCCH message transmitting the MBMS and a resource configuration information, a physical layer signaling message or a signaling message newly added and dedicated to notify the UE to respond the service reception state of the MBMS; and
the transmitting module transmits the service reception state of the MBMS according to the indicator, or
wherein the service reception state of the MBMS comprises an MBSFN area ID information corresponding to the service reception state of the MBMS responded by the UE.

23. (canceled)

24. The user equipment according to claim 22, wherein the service reception state of the MBMS further comprises an MBMS ID information corresponding to the service reception state of the MBMS responded by the UE.
